(19) United States
(12) Patent Application Publication
(10) Pub. No.: US 2009/0229186 A1
(43) Pub. Date: Sep. 17, 2009

(54) REFRIGERATOR DOOR OPENING APPARATUS

(76) Inventor: Keon-Woo PARK, Seoul (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/056,807

(22) Filed: Mar. 27, 2008

(30) Foreign Application Priority Data
Mar. 11, 2008 (KR) 10-2008-0022629

(51) Int. Cl. E05F 11/12

(52) U.S. Cl. 49/276

(57) ABSTRACT

provided is a refrigerator door opening apparatus comprises: a foot pedal; a sliding unit for sliding said foot pedal downwardly; and a unit for providing a repelling force with a first and a second portions, the first portion coupled with the foot pedal and the second portion located separately from the first portion.

### BACKGROUND OF THE INVENTION

1. Field of the Invention

The present invention relates to a refrigerator door opening apparatus, and more particularly to a refrigerator door opening apparatus capable of easily and conveniently opening a refrigerator door, without supplying an electric power.

2. Description of Related Art

Conventionally, a refrigerator door comprises a gasket made of soft synthetic resins, and a permanent magnet. The gasket is attached to the refrigerator door along an outer periphery surface inside thereof. The permanent magnet is installed in the gasket.

When the refrigerator door is in a closed state, the refrigerator door is maintained in the closed state due to a magnetic attraction of the permanent magnet. In addition, when a user will open the refrigerator door while gripping a knob thereof, it is necessary for the user to pull with all one's strength. Therefore, the users such as children, seniors, and handicapped people cannot easily open the refrigerator door, thereby there is a difficult to open the refrigerator door.

In addition, when the user is in holding things in both hands, it is not easy to open the door of the refrigerator.

To solve the above-mentioned problem, Korean Utility Model No. 20-0368371 discloses an apparatus for opening a refrigerator door in such a manner that electric current is supplied to electromagnets installed along outer peripheral side of the refrigerator door, and being operated by a separate switch, thereby causing repelling force between the electromagnets and then opening the refrigerator door. However, when such electromagnets are used, it is lead to power consumption, and thus the cost of maintenance is higher. In addition, since such conventional refrigerator ought to have additional components, such as power supply, switch and the like, for operating the electromagnet, the manufacturing cost of the conventional refrigerator also is higher.

### SUMMARY OF THE INVENTION

Therefore, the present invention has been made in view of the above-mentioned problems, and an object of the present invention is to provide a refrigerator door opening apparatus capable of easily and conveniently opening a refrigerator door without supplying an electric power, even when a user holds things in both hands. Also, another object of the present invention is to provide a refrigerator door opening apparatus in which the maintenance cost and the manufacturing cost of a refrigerator can be reduced.

In accordance with an aspect of the present invention, there is provided an apparatus an apparatus opening a refrigerator door, comprising: a foot pedal; a sliding unit for sliding the foot pedal downwardly; and a unit for providing a repelling force with a first and a second portions, the first portion coupled with the foot pedal and the second portion located separately from the first portion.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a perspective view showing a refrigerator door opening apparatus according to a first embodiment of the present invention.

FIG. 2 is an exploded perspective view showing the refrigerator door opening apparatus.

FIG. 3 is an exploded perspective view showing a foot pedal sliding unit which is comprised in the refrigerator door opening apparatus.

FIG. 4 is an exploded perspective view showing a foot pedal and a first operating unit which are comprised in the refrigerator door opening apparatus

FIG. 5 is an exploded perspective view showing a second operating unit which is comprised in the refrigerator door opening apparatus. As shown in FIGS. 1 to 5, the refrigerator door opening apparatus according to the first embodiment comprises a foot pedal sliding unit 100; a foot pedal 110 coupled to a first operating unit 120; and a second operating unit 200.

FIGS. 6 and 7 are the drawings showing another embodiment of this invention.

FIGS. 8 and 9 are the drawings showing another embodiment of this invention.

### DESCRIPTION OF SPECIFIC EMBODIMENTS

The advantages, features and aspects of the invention will become apparent from the following description of the embodiments with reference to the accompanying drawings, which is set forth hereinafter.

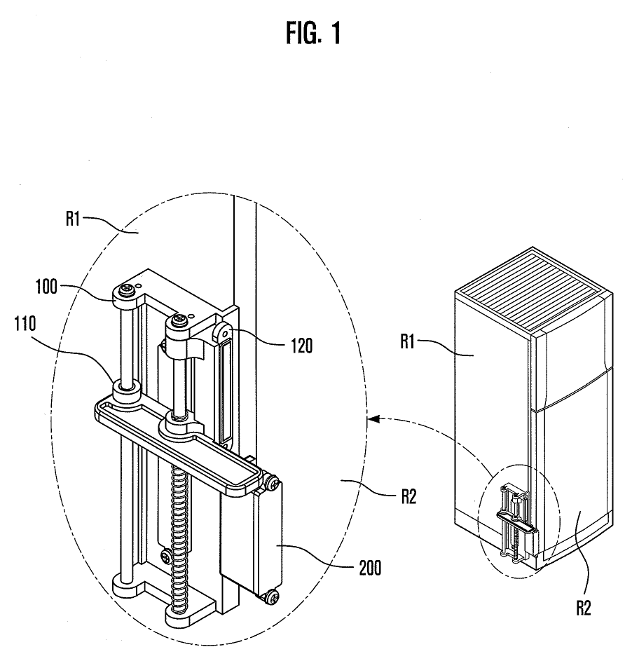

As illustrated in FIG. 1, the first pedal sliding unit 100 is attached to or installed in an opened lower side of a refrigerator body R1 so as to support the operation transmitting unit 110 described later in detail. The foot pedal sliding unit 100 is coupled to the foot pedal 110 through at least one of a shaft 10A vertically fixed to the foot pedal sling unit 100, and thus the foot pedal 110 can movable vertically along the shaft 10A.

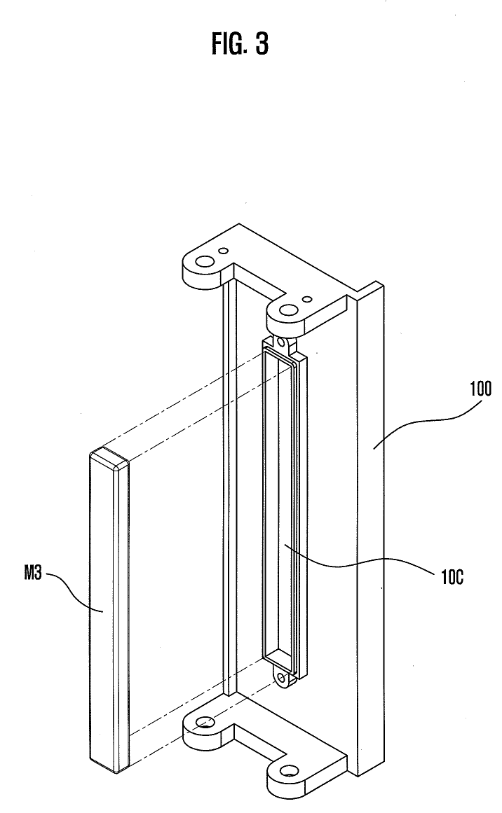

If the foot pedal sliding unit 100 is attached to an outer surface of the refrigerator body R1, the foot pedal sliding unit 100 may be attached to the refrigerator body R1, but not limited, by means of various coupling methods, such as adhesion, glue, hook, and the like. For example, as shown in FIG. 3, the foot pedal sliding unit 100 may be attached to the refrigerator body R1 by magnetic force of a permanent magnet, which is fixed to an elongated recess 10C formed on central portion of the foot pedal sliding unit 100.

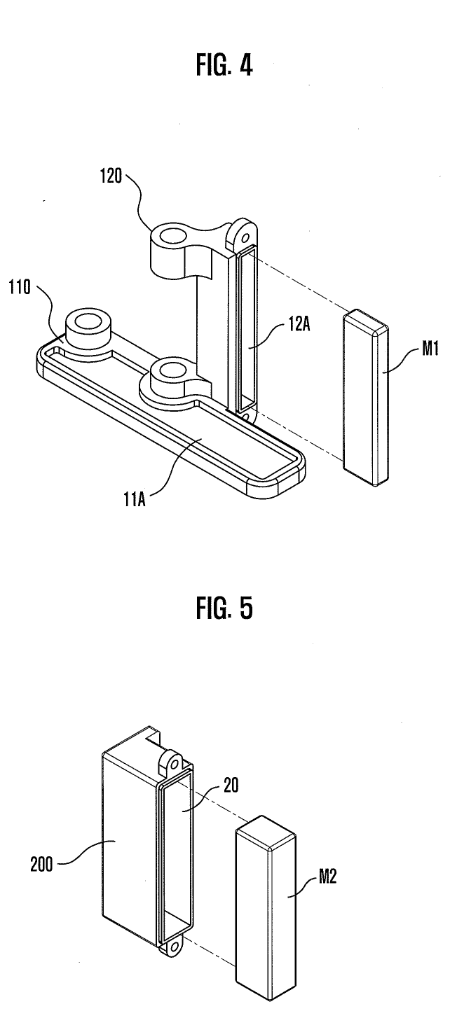

The foot pedal 110 is coupled to the first operating unit 120, and may be movably coupled to the foot pedal sliding unit 100 through at least one of the shaft 10A. When the first operating unit 120 is vertically and downwardly moved along the shaft 10A of the foot pedal sliding unit 100, it makes possible for the first operating unit 120 to operate a second support unit 200 to be descried later in detail. As shown in FIG. 4, a magnet installing portion 12A is formed on the first operating unit 120, and a permanent magnet M1 is installed to the magnet installing portion 12A.

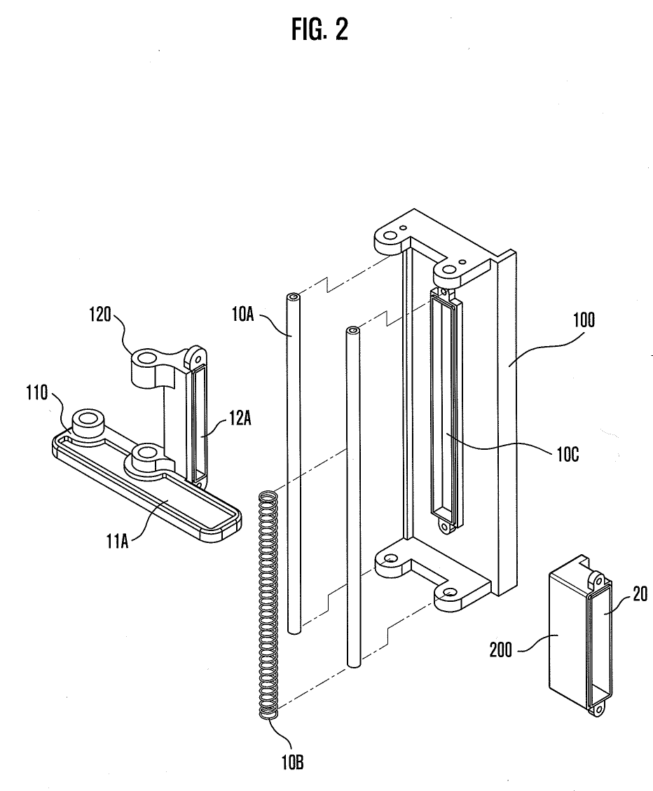

The foot pedal 120 includes a plate-shaped portion 11A in which a user pushes down it using one's foot, for example. An elastic member 10B (see FIG. 2) is disposed on the shaft 10A of the foot pedal sliding unit 100, below the plate-shaped portion 11A. Therefore, after the plate-shaped portion 11A is vertically pushed down by a physical part, for example a foot, and the plate-shaped portion 11A can be returned to initial position thereof by means of the elastic member 10B.

The elastic member 10B can be formed with a coil spring shown in FIG. 2. However, the elastic member 10B may be employed as a rubber, hydraulic system and the like, but not limited as long as the elastic member 10B can make the plate-shaped portion 11A to be returned to initial position thereof using force of restitution.

The second operating unit 200, as shown in FIG. 2, is attached to the left downside corner of the refrigerator door, or according to the position of the first operating unit, may be placed inside the door. When anyone pushes downwardly the foot pedal 110 to open automatically the door, the first operating unit 120 and the second operating unit 200 are placed to face each other to open it. At this time, they may include permanent magnets M1 and M2 each other with opposite polarity. A magnet acceptable space 20 is formed in the second operating unit 200 to accept the magnet M2, as shown in FIG. 5, with the opposite polarity against the magnet M1 of the first operating unit 120. The second operating unit 200 may be attached to the door R2 by using the permanent magnet M2 itself, or any other methods like adhesion, glue, hook, etc. Therefore, when anyone moves vertically and downwardly the foot pedal 110, the permanent magnets M1 and M2 are arranged to face each other, and at this time, by the repelling force of two magnets the door is bound to be opened.

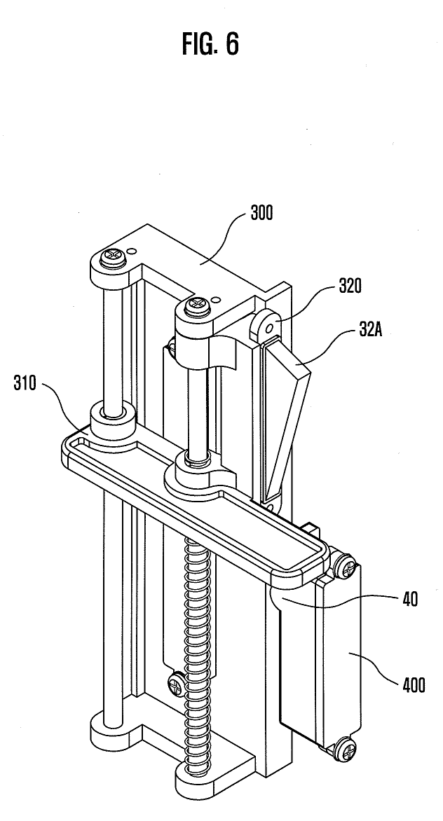

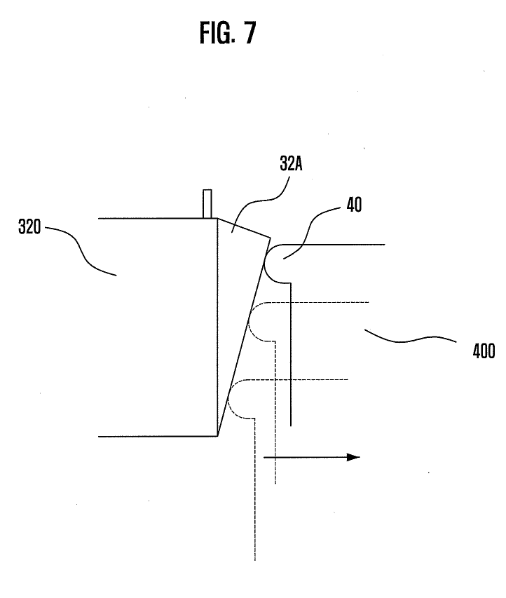

FIGS. 6 and 7 are the drawings showing another embodiment of this invention. This door opening apparatus comprises a foot pedal sliding unit 300, a foot pedal 310 coupled to a first operating unit 320, and a second operating unit 400. Except the operation of the first and second operating units 320 and 400, the other operations are the same as the prior embodiment. At this embodiment, the first operating unit 320 includes a sloped protrusion 32A, and the second operating unit 400 includes a convexity 40. When the foot pedal 310 is moved vertically and downwardly, the sloped protrusion 32A passes by the convexity 40, and the refrigerator door is bound to be opened.

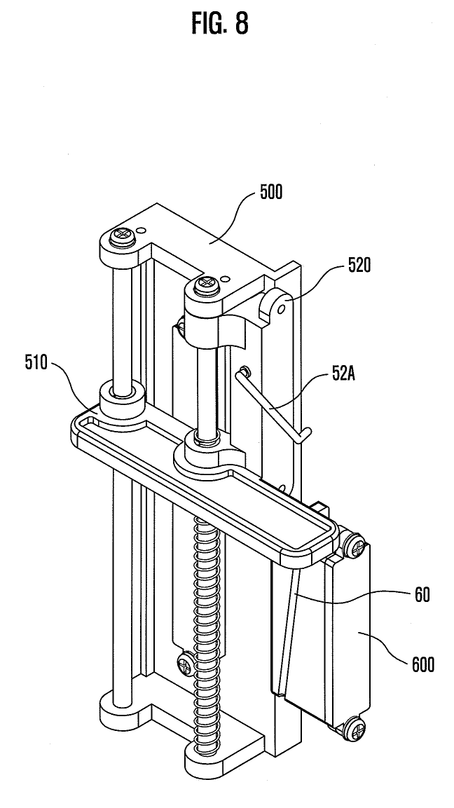

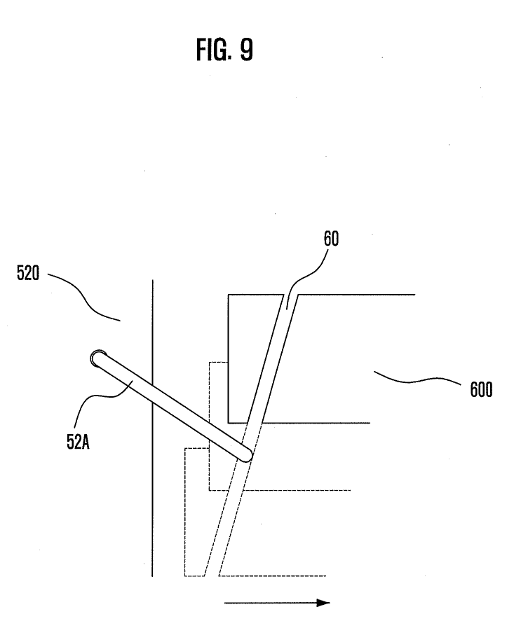

FIGS. 8 and 9 are the drawings showing another embodiment of this invention. This door opening apparatus comprises a foot pedal sliding unit 500, a foot pedal 510 coupled to a first operating unit 520, and a second operating unit 600. Except the operation of the first and second operating units 520 and 600, the other operations are the same as the prior embodiments. At this embodiment, the first operating unit 520 includes a projected bar 52A having “L” shape, and the second operating unit 600 forms a sloped hole 60 so as to guide the projected bar 52A along the hole 60. Therefore, by the movement of the foot pedal 510, the projected bar 52A is moved along the hole 60, and the refrigerator door is opened.

The present application contains subject matter related to Korean Patent Application No. 10-2008-0022629, filed in the Korean Intellectual Property Office on Mar. 11, 2008, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

What is claimed is:

1. An apparatus opening a refrigerator door, comprising:
a foot pedal;
a sliding means for sliding said foot pedal downwardly; and
a means for providing a repelling force with a first and a second portions, the first portion coupled with the foot pedal and the second portion located separately from the first portion.

2. The apparatus of claim 1, wherein said first portion includes a permanent magnet.

3. The apparatus of claim 2, wherein said second portion includes a permanent magnet.

4. The apparatus of claim 1, wherein said second portion includes a permanent magnet.

5. The apparatus of claim 1, wherein said sliding means includes at least one shaft for sliding vertically said foot pedal, and at least one elastic member for recovering said foot pedal to an initial position.

6. The apparatus of claim 1, wherein said first portion includes a sloped protrusion.
